(19) United States
(12) Patent Application Publication
(10) Pub. No.: US 2026/0333334 A1
(43) Pub. Date: Oct. 22, 2026

(54) METHOD AND DEVICE FOR SYNCHRONIZATION SIGNAL-BASED BEAM TRACKING AND MANAGEMENT IN SIDELINK COMMUNICATION

(71) Applicants: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(72) Inventors: Ui Hyun HONG, Hwaseong-si, Gyeonggi-do (KR); Hyuk Min SON, Seoul (KR)

(73) Assignees: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(21) Appl. No.: 19/101,474

(22) PCT Filed: Sep. 22, 2023
(86) PCT No.: PCT/KR2023/014467

§ 371 Date: Feb. 5, 2025

(30) Foreign Application Priority Data
Oct. 6, 2022 (KR) 10-2022-0127912

(51) Int. Cl. H04W 72/044; H04W 72/40

(52) U.S. Cl. CPC H04W 72/046; H04W 72/40

(57) ABSTRACT

A method and a device for synchronization signal-based beam tracking and management in sidelink communication are disclosed. A method for a first UE comprises the steps of: transmitting a BSI request to a second UE; transmitting, to the second UE, first S-SSBs according to the BSI request; and receiving, from the second UE, first BSI measured on the basis of the first S-SSBs.

### TECHNICAL FIELD

The present disclosure relates to a sidelink communication technique, and more particularly, to a technique for tracking and managing beams based on synchronization signals.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, beam tracking and/or beam management operations for sidelink communication may be required. The beam tracking/management operations can be performed based on channel state information-reference signals (CSI-RS). Additionally, beam tracking/management operations using sidelink-synchronization signal blocks (S-SSB) may be considered. In this case, specific procedures for beam tracking/management operations using S-SSBs may be required.

### DISCLOSURE

### Technical Problem

The present disclosure is directed to providing a method and an apparatus for tracking and managing beams in sidelink communication.

### Technical Solution

A method of a first user equipment (UE), according to exemplary embodiments of the present disclosure for achieving the above-described objective, may comprise: transmitting a beam state information (BSI) request to a second UE; transmitting first sidelink-synchronization signal blocks (S-SSBs) according to the BSI request to the second UE; and receiving first BSI measured based on the first S-SSBs from the second UE.

The BSI request may include configuration information of the first S-SSBs, and the configuration information may include at least one of time resource information, frequency resource information, or transmission periodicity information of the first S-SSBs.

The first S-SSBs may be configured for beam management operations, and the first S-SSBs may be distinguished from S-SSBs configured for synchronization.

The BSI request may include information indicating whether to perform BSI reporting, the first BSI may be received from the second UE when the information indicates that BSI reporting is to be performed, and the first BSI may not be received from the second UE when the information indicates that BSI reporting is not to be performed.

The BSI request may be included in sidelink control information (SCI), medium access control (MAC) control element (CE), or radio resource control (RRC) message transmitted to the second UE.

The first BSI may include measurement information for beams of the first UE and information indicating whether to stop S-SSB transmission, the first UE may stop S-SSB transmission after receiving the first BSI when the information indicates that S-SSB transmission is to be stopped, and the first UE may perform S-SSB transmission after receiving the first BSI when the information indicates that S-SSB transmission is not to be stopped.

The method may further comprise: transmitting second S-SSBs to the second UE; and receiving second BSI measured based on the second S-SSBs from the second UE, wherein the first S-SSBs constitute a first S-SSB group, the second S-SSBs constitute a second S-SSB group, and BSI measurement operations in the second UE may be performed on an S-SSB group basis.

The method may further comprise: receiving a beam management (BM) request from the second UE, wherein the BM request may include information indicating whether a beam management operation is required, the first UE may transmit the BSI request when the information indicates that a beam management operation is required, and the first UE may not transmit the BSI request when the information indicates that a beam management operation is not required.

A method of a second user equipment (UE), according to exemplary embodiments of the present disclosure for achieving the above-described objective, may comprise: receiving a beam state information (BSI) request from a first UE; receiving first sidelink-synchronization signal blocks (S-SSBs) according to the BSI request from the first UE; generating first BSI by performing beam measurement operations based on the first S-SSBs; and transmitting the first BSI to the first UE.

The BSI request may include configuration information of the first S-SSBs, and the configuration information may include at least one of time resource information, frequency resource information, or transmission periodicity information of the first S-SSBs.

The first S-SSBs may be configured for beam management operations, and the first S-SSBs may be distinguished from S-SSBs configured for synchronization.

The BSI request may include information indicating whether to perform BSI reporting, the second UE may transmit the first BSI to the first UE when the information indicates that BSI reporting is to be performed, and the second UE may not transmit the first BSI to the first UE when the information indicates that BSI reporting is not to be performed.

The BSI request may be included in sidelink control information (SCI), medium access control (MAC) control element (CE), or radio resource control (RRC) message received from the first UE.

The first BSI may include measurement information for beams of the first UE and information indicating whether to stop S-SSB transmission, the second UE may stop S-SSB reception after transmitting the first BSI when the information indicates that S-SSB transmission is to be stopped, and the second UE may perform S-SSB reception after transmitting the first BSI when the information indicates that S-SSB transmission is not to be stopped.

The method may further comprise: receiving second S-SSBs from the first UE; generating second BSI by performing beam measurement operations based on the second S-SSBs; and transmitting the second BSI to the first UE, wherein the first S-SSBs constitute a first S-SSB group, the second S-SSBs constitute a second S-SSB group, and the second UE may perform the beam measurement operations on an S-SSB group basis.

The method may further comprise: transmitting a beam management (BM) request to the first UE, wherein the BM request includes information indicating whether a beam management operation is required, the second UE may perform a reception operation for the BSI request when the information indicates that a beam management operation is required, and the second UE may not perform a reception operation for the BSI request when the information indicates that a beam management operation is not required.

A first user equipment (UE), according to exemplary embodiments of the present disclosure for achieving the above-described objective, may comprise: at least one processor, wherein the at least one processor may cause the first UE to perform: transmitting a beam state information (BSI) request to a second UE; transmitting first sidelink-synchronization signal blocks (S-SSBs) according to the BSI request to the second UE; and receiving first BSI measured based on the first S-SSBs from the second UE.

The BSI request may include configuration information of the first S-SSBs, the configuration information includes at least one of time resource information, frequency resource information, or transmission periodicity information of the first S-SSBs, the first S-SSBs are configured for beam management operations, and the first S-SSBs are distinguished from S-SSBs configured for synchronization.

The at least one processor may cause the first UE to perform: transmitting second S-SSBs to the second UE; and receiving second BSI measured based on the second S-SSBs from the second UE, wherein the first S-SSBs constitute a first S-SSB group, the second S-SSBs constitute a second S-SSB group, and BSI measurement operations in the second UE may be performed on an S-SSB group basis.

The at least one processor causes the first UE to perform: receiving a beam management (BM) request from the second UE, wherein the BM request may include information indicating whether a beam management operation is required, the first UE transmits the BSI request when the information indicates that a beam management operation is required, and the first UE may not transmit the BSI request when the information indicates that a beam management operation is not required.

### Advantageous Effects

According to the present disclosure, a transmitting terminal can transmit a Beam State Information (BSI) request to a receiving terminal and can transmit S-SSBs corresponding to the BSI request to the receiving terminal. The receiving terminal can transmit BSI to the transmitting terminal by performing measurement operations on the S-SSBs. Based on these operations, S-SSB-based beam management operations can be performed, and SL communication can be efficiently carried out.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a conceptual diagram illustrating a first exemplary embodiment of an S-SSB.

FIG. 10 is a conceptual diagram illustrating a first exemplary embodiment of an S-SSB period.

FIG. 11 is a sequence chart illustrating a first exemplary embodiment of a beam management method.

FIG. 12 is a sequence chart illustrating a second exemplary embodiment of a beam management method.

FIG. 13 is a sequence chart illustrating a third exemplary embodiment of a beam management method.

FIG. 14 is a sequence chart illustrating a fourth exemplary embodiment of a beam management method.

FIG. 15 is a sequence chart illustrating a fifth exemplary embodiment of a beam management method.

FIG. 16 is a sequence chart illustrating a sixth exemplary embodiment of a beam management method.

FIG. 17 is a sequence chart illustrating a seventh exemplary embodiment of a beam management method.

FIG. 18 is a sequence chart illustrating an eighth exemplary embodiment of a beam management method.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like. In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

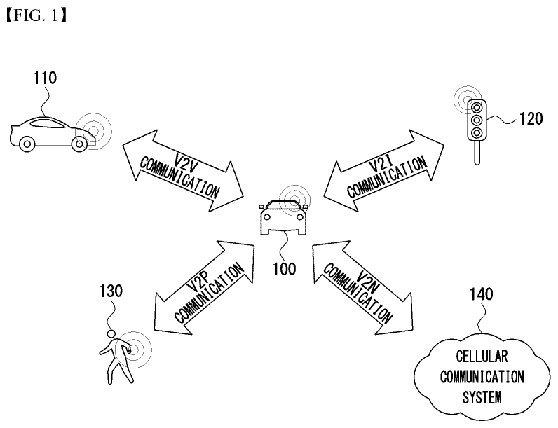

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

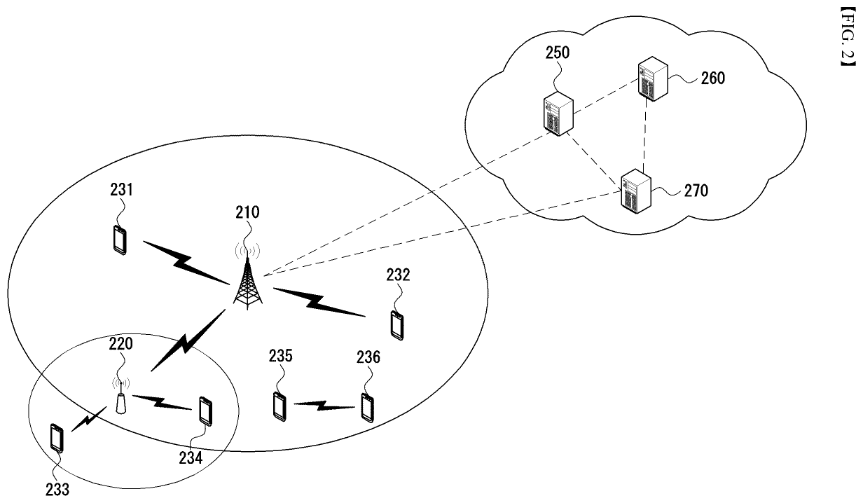

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

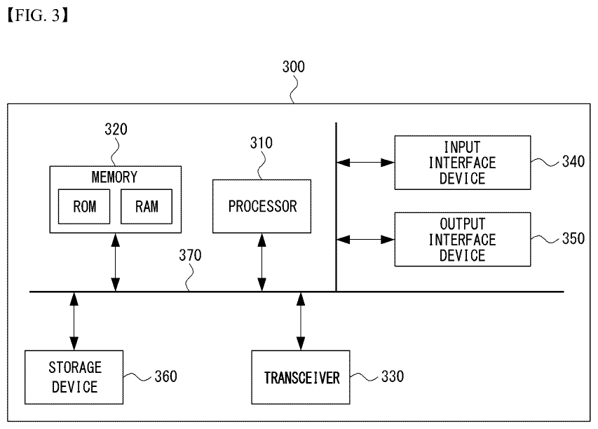

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

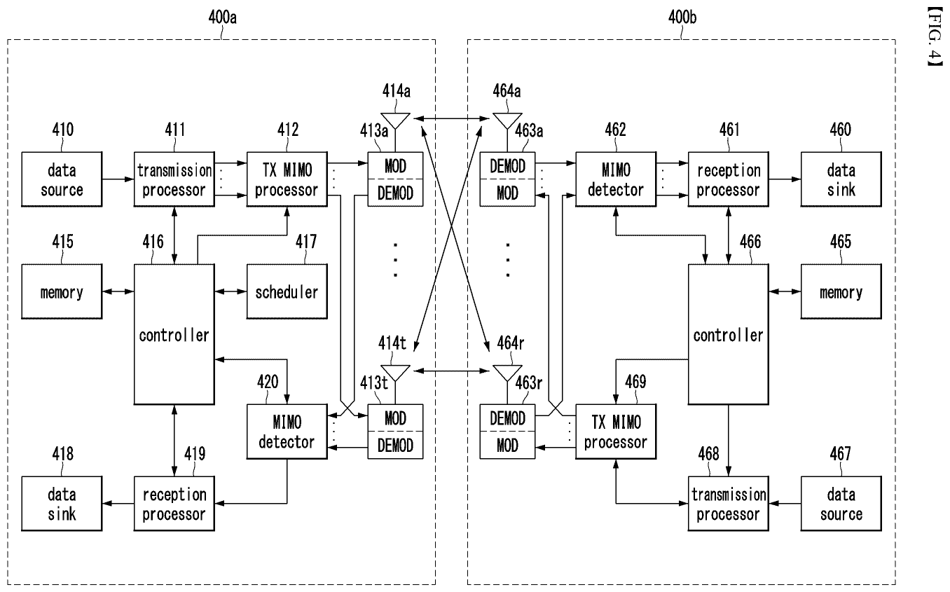

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

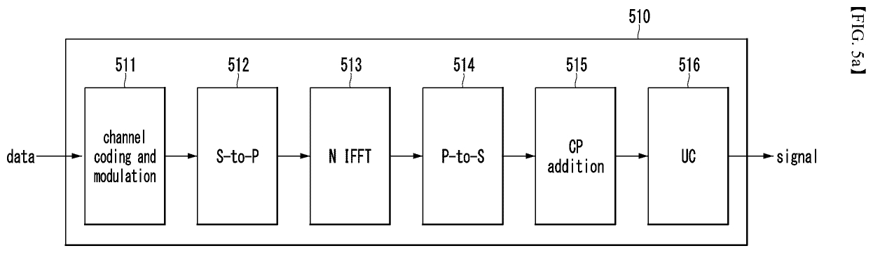

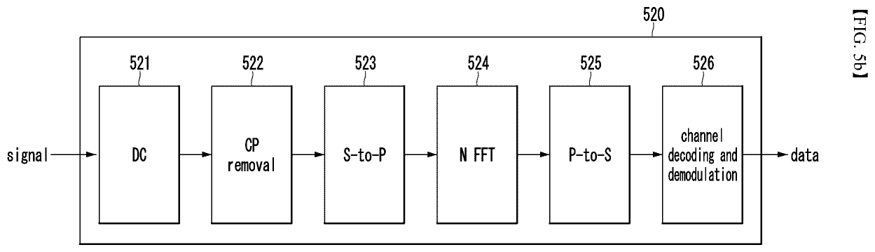

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of | Out of coverage of |
| | base station 210 | base station 210 |
| C | In coverage of | In coverage of |
| | base station 210 | base station 210 |
| D | In coverage of | In coverage of other |
| | base station 210 | base station |

Meanwhile, a user plane protocol stack of the UEs (e.g., the UEs 235 and 236) performing sidelink communications may be configured as follows.

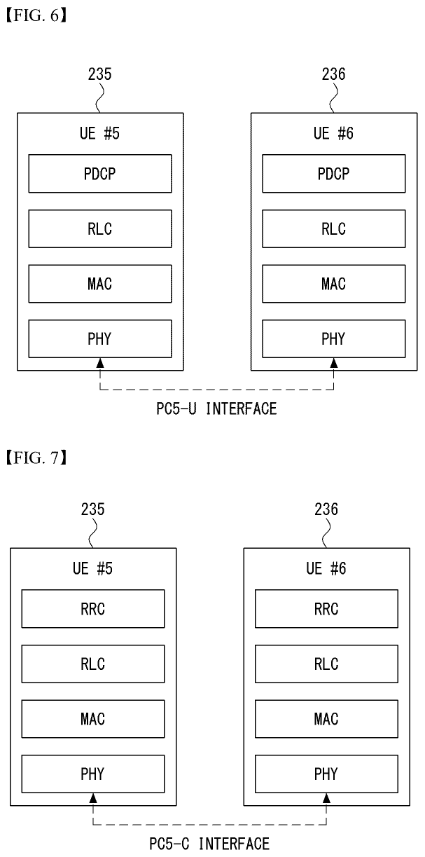

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

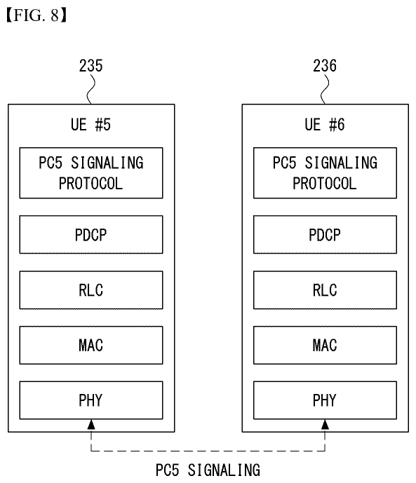

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink | |
|---|---|
| TM | Description |
| 1 | Transmission using resources scheduled by base station |
| 2 | UE autonomous transmission without scheduling of base station |
| 3 | Transmission using resources scheduled by base station in V2X |
| | communications |
| 4 | UE autonomous transmission without scheduling of base station |
| | in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, sidelink (SL) communication may support beam management operations. The beam management operations may be supported in an FR2 band. In the present disclosure, the beam management operations may refer to operations that include beam tracking operations. The beam management operations may be performed based on at least one of aperiodic channel state information (CSI) reporting, periodic CSI reporting, or semi-persistent CSI reporting. SCI (e.g., SCI format 2-A and/or 2-C) may include a CSI request field, and the beam management operations may be performed based on an aperiodic CSI report triggered by the SCI.

A first terminal may transmit a CSI-RS (e.g., CSI-RS for beam management) in each of symbols belonging to an SL slot. The first terminal may transmit the CSI-RS based on a beam sweeping operation. In other words, the first terminal may transmit the CSI-RS using different beams (e.g., different transmission beams) in the respective symbols belonging to the SL slot. A second terminal may receive the CSI-RS from the first terminal. A reception operation for the CSI-RS may be performed based on a beam sweeping operation. For example, the second terminal may perform the reception operation for the CSI-RS using different beams (e.g., different reception beams). If the transmission and reception operations of the CSI-RS (e.g., reference signal) are performed based on the beam sweeping operations, resources for CSI-RS transmission and reception may be insufficient.

When resources for beam sweeping operations of the reference signals are allocated, symbols for SL data transmission (e.g., PSSCH symbols) may be insufficient. Therefore, beam management operations based on signals (e.g., synchronization signals) other than reference signals may be required in SL communication.

Beam management operations in an NR Uu link may be defined as follows.
Signals used for CSI measurement: a CSI-RS set and/or synchronization signal blocks (SSBs)
channel quality indicator (CQI) metric for beams: L1-reference signal received power (RSRP)
Maximum number of CSIs that can be reported for each terminal: 4 (e.g., CSI reporting for 4 beams is possible)
Reported information: The largest L1-RSRP among L1-RSRPs of beams and/or differences between the largest L1-RSRP and L1-RSRPs of the remaining beams
CSI-RS transmission type: CSI reporting type+channel used for CSI reporting
Periodic type: periodic CSI reporting+physical uplink control channel (PUCCH)
Semi-persistent type: periodic CSI reporting+PUCCH or semi-persistent CSI reporting+physical uplink shared channel (PUSCH)
Aperiodic type: aperiodic CSI reporting (e.g., aperiodic CSI reporting triggered by DCI with a CSI request field)+PUSCH
Beam adjustment for each of downlink transmission and reception beams may be performed. If beam reciprocity is established between uplink and downlink, beam management operations (e.g., beam adjustment operations) may only be performed for downlink.

CSI-related operations in an NR SL link may be defined as follows.
Signals used for CSI measurement: CSI-RS set
CQI metric: L1-RSRP
Maximum CSI-RS ports: 2
CSI-RS transmission type: CSI reporting type+channel used for CSI reporting
Aperiodic type: aperiodic CSI reporting (e.g., aperiodic CSI reporting triggered by SCI format 2-A or 2-C with a CSI request field)+PSSCH (e.g., MAC CE)

Sidelink-synchronization signal block (S-SSB)-related operations in NR communication may be defined as follows.
Unlike SSB transmission in the NR Uu link, S-SSB transmission in the NR SL link may be performed at a fixed periodicity. The fixed periodicity may be 160 ms.
As shown in Table 3 below, transmission of multiple S-SSBs within one S-SSB period may be possible depending on a frequency range (FR) and/or subcarrier spacing (SCS).

TABLE 3

| FR | SCS | Number of S-SSBs within an S-SSB period |
|---|---|---|
| FR1 | 15 kHz | 1 |
| | 30 kHz | 1, 2 |
| | 60 kHz | 1, 2, 4 |
| FR2 | 60 kHz | 1, 2, 4, 8, 16, 32 |
| | 120 kHz | 1, 2, 4, 8, 16, 32, 64 |

In SL communication, S-SSBs may be used for beam management (e.g., beam quality measurement) for beams (e.g., transmission beams and/or reception beams) between a transmitting terminal and a receiving terminal. In other words, beam management operations may be performed using S-SSBs.

In the present disclosure, a terminal transmitting S-SSBs for beam information measurement may be referred to as a transmitting terminal (or a first terminal), and a terminal receiving the S-SSBs may be referred to as a receiving terminal (or a second terminal). The receiving terminal may obtain (e.g., measure) beam information based on the S-SSBs and may report the beam information to the transmitting terminal when necessary. The beam information measured by the receiving terminal may be defined as beam state information (BSI). For example, the BSI may include an index of a specific beam, beam quality information (e.g., RSRP, reference signal received quality (RSRQ), received signal strength indicator (RSSI), etc.), and/or calculation results for beam quality measured values (e.g., RSRP, RSRQ, RSSI, etc.).

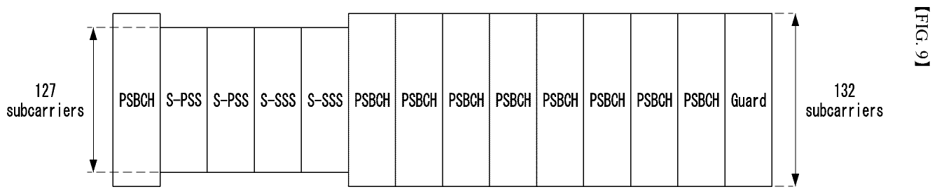

FIG. 9 is a conceptual diagram illustrating a first exemplary embodiment of an S-SSB.

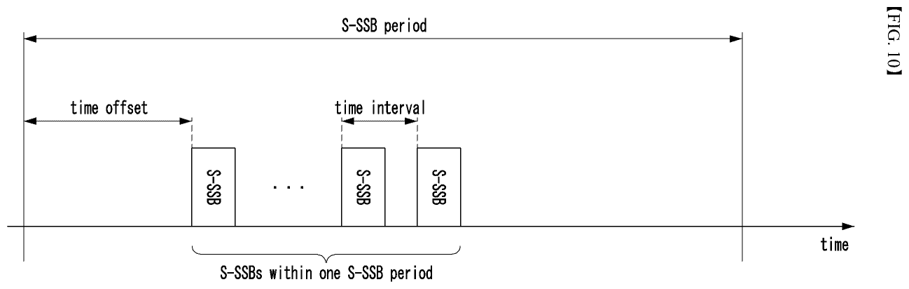

As shown in FIG. 9, an S-SSB may include a sidelink-primary synchronization signal (S-PSS), a sidelink-secondary synchronization signal (S-SSS), and a PSBCH. The S-SSB may further include a PSBCH DMRS. The PSBCH DMRS may be a DMRS used for demodulation of the PSBCH. The S-SSB may be transmitted within a single slot. In the S-SSB illustrated in FIG. 9, a normal cyclic prefix (CP) may be applied. In the present disclosure, the S-SSB illustrated in FIG. 9, a variant S-SSB from the S-SSB illustrated in FIG. 9, an extended S-SSB from the S-SSB illustrated in FIG. 9, and/or a combined S-SSB from the S-SSB illustrated in FIG. 9 may be used. FIG. 10 is a conceptual diagram illustrating a first exemplary embodiment of an S-SSB period.

As shown in FIG. 10, one or more S-SSBs may be transmitted within an S-SSB period. A periodicity of the S-SSB period may be 160 ms. The periodicity of the S-SSB period may be a fixed periodicity. A time offset from a start time of the S-SSB period to a transmission time of the first S-SSB and/or a time interval between the S-SSBs may be configured to terminal(s) through signaling. A terminal may transmit S-SSB(s) in various manners based on the time offset and/or the time interval. In the present disclosure, the S-SSB period illustrated in FIG. 10, a variant S-SSB period from the S-SSB period illustrated in FIG. 10, an extended S-SSB period from the S-SSB period illustrated in FIG. 10, and/or a combined S-SSB period from the S-SSB period illustrated in FIG. 10 may be used.

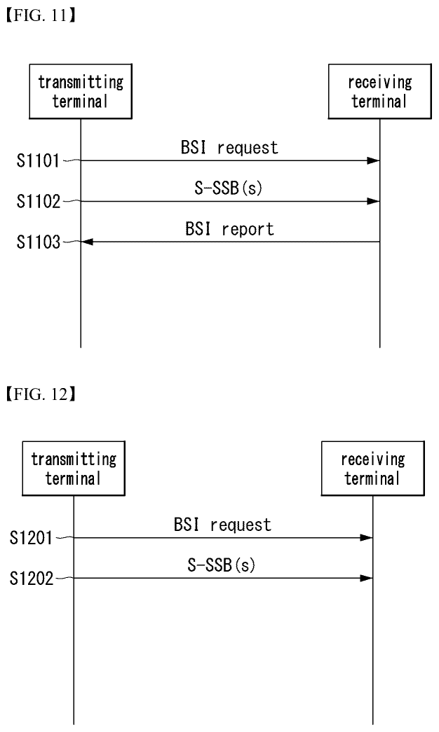

FIG. 11 is a sequence chart illustrating a first exemplary embodiment of a beam management method, and FIG. 12 is a sequence chart illustrating a second exemplary embodiment of a beam management method.

As shown in FIG. 11 and FIG. 12, a transmitting terminal may transmit a beam state information (BSI) request to a receiving terminal (S1101, S1201). The receiving terminal may receive the BSI request from the transmitting terminal. The BSI request may indicate transmission of S-SSB(s) for BSI measurement. When the BSI request is received from the transmitting terminal, the receiving terminal may determine that S-SSB(s) (e.g., S-SSB(s) according to the BSI request or S-SSB(s) associated with the BSI request) are transmitted from the transmitting terminal. After the transmission of the BSI request, the transmitting terminal may transmit S-SSB(s) to the receiving terminal (S1101, S1201). The transmission of the S-SSB(s) may be triggered by the BSI request. The S-SSB(s) may be associated with the BSI request. For example, the S-SSB(s) may be S-SSB(s) for beam management operations, and the S-SSB(s) for beam management operations may be configured to be distinguished from S-SSB(s) for synchronization. Alternatively, the S-SSB(s) for beam management operations may be the same as S-SSB(s) for synchronization.

The transmitting terminal may transmit the S-SSBs based on a beam sweeping scheme. In other words, the transmitting terminal may transmit the S-SSBs using different beams. The receiving terminal may receive the S-SSB(s) from the transmitting terminal and may perform beam measurement operations (e.g., BSI measurement operations) based on the S-SSB(s). In the exemplary embodiment of FIG. 11, the receiving terminal may generate BSI, which include measurement results of the beams, and may report the BSI to the transmitting terminal (S1103). The transmitting terminal may receive the BSI from the receiving terminal and may perform beam management operations based on the BSI. For example, the transmitting terminal may change or maintain transmission beam(s) based on the BSI. In the exemplary embodiment of FIG. 12, the receiving terminal may not perform BSI reporting.

The BSI request may be transmitted to the receiving terminal through signaling (e.g., RRC signaling, MAC signaling (e.g., MAC CE), and/or PHY signaling (e.g., SCI)). The BSI request may include full or partial information on an S-PSS and/or S-SSS included in the S-SSB. The BSI request may include full or partial information of an sidelink synchronization signal (SLSS) identifier (ID) for identifying the S-SSB transmitted by the transmitting terminal. The transmitting terminal may determine the SLSS ID using an SLSS ID generation scheme classified based on a priority level. The priority level may be determined according to a location of the terminal (e.g., within a coverage of a base station or outside a coverage of a base station) and/or a type of synchronization source.

The BSI request may include S-SSB configuration information. The S-SSB configuration information may include at least one of full or partial information of time resource(s) where S-SSB(s) are transmitted, full or partial information of frequency resource(s) where S-SSB(s) are transmitted, information on a transmission interval between S-SSBs, or information on a transmission periodicity of S-SSB(s). The BSI request may include information on a time offset from a transmission time of the BSI request to a start time of a slot where the first S-SSB (e.g., the first S-SSB transmission triggered by the BSI request) is transmitted. The BSI request may include information on a time offset from a start time of an S-SSB period after the BSI request to a transmission time of the first S-SSB (e.g., the first S-SSB transmission triggered by the BSI request) within the S-SSB period. The start time of the slot where the S-SSB is transmitted and/or the start time of the S-SSB period may be determined based on a system frame number (SFN), direct frame number (DFN), and/or configuration values of the S-SSB period.

The BSI request may include information on the number of S-SSBs transmitted within one S-SSB period and/or information on a time interval between S-SSBs within one S-SSB period. The BSI request may indicate whether to report beam information (e.g., BSI) measured based on S-SSB(s). A reporting indicator indicating whether to perform BSI reporting may have a size of 1 bit. The reporting indicator set to a first value (e.g., 0) may indicate that BSI reporting is not performed. In this case, the receiving terminal may not transmit BSI to the transmitting terminal, and the transmitting terminal may not expect to receive BSI from the receiving terminal. The reporting indicator set to a second value (e.g., 1) may indicate that BSI reporting is performed. In this case, the receiving terminal may transmit BSI to the transmitting terminal, and the transmitting terminal may expect to receive BSI from the receiving terminal.

The BSI request may be transmitted through a PSCCH and/or PSSCH. For example, the BSI request may be included in SCI and/or MAC CE. The BSI reporting may be activated or deactivated. If BSI reporting is activated by SCI or MAC CE, the receiving terminal may perform BSI reporting in response to the BSI request. If BSI reporting is deactivated by SCI or MAC CE, the receiving terminal may not perform BSI reporting in response to the BSI request. Alternatively, whether to perform BSI reporting (e.g., BSI reporting in response to the BSI request) may be preconfigured. Whether to perform BSI reporting may be preconfigured through SI signaling and/or RRC signaling. Whether to perform BSI reporting may be configured in a resource pool-specific, sidelink-specific, and/or UE-specific manner.

If the BSI request includes information indicating that BSI reporting is performed, as in the exemplary embodiment of FIG. 11, the receiving terminal may measure transmission beam(s) of the transmitting terminal based on the S-SSB(s) and may report measurement information of the transmission beam(s) (e.g., BSI) to the transmitting terminal. If the BSI request includes information indicating that BSI reporting is not performed, as in the exemplary embodiment of FIG. 12, the receiving terminal may measure reception beam(s) based on the S-SSB(s) and may not report measurement information of the reception beam(s) (e.g., BSI) to the transmitting terminal.

The BSI request may include information indicating measurement operations for transmission beams and/or reception beams, and the information included in the BSI request may implicitly indicate whether to perform BSI reporting. If the BSI request includes information indicating the measurement operation for reception beams (e.g., reception beams of the receiving terminal), the receiving terminal may not perform BSI reporting. In other words, information indicating the measurement operation for reception beams may implicitly indicate that BSI reporting is not performed. If the BSI request includes information indicating the measurement operation for transmission beams (e.g., transmission beams of the transmitting terminal), the receiving terminal may perform BSI reporting. In other words, information indicating the measurement operation for transmission beams may implicitly indicate that BSI reporting is performed.

Alternatively, information included in the BSI request, which indicates whether to perform BSI reporting, may implicitly indicate the measurement operations for transmission beams and/or reception beams. If the BSI request includes information indicating that BSI reporting is performed, the receiving terminal may perform the measurement operation for the transmission beam(s) of the transmitting terminal and may report measurement information of the transmission beam(s) (e.g., BSI) to the transmitting terminal. In other words, the information indicating that BSI reporting is performed may implicitly indicate that the measurement operation for transmission beams is performed. If the BSI request includes information indicating that BSI reporting is not performed, the receiving terminal may perform the measurement operation for the reception beam(s) of the receiving terminal and may not report measurement information of the reception beam(s) to the transmitting terminal. In other words, the information indicating that BSI reporting is not performed may implicitly indicate that the measurement operation for reception beams is performed. The measurement operation for reception beams may be performed by sweeping the reception beams of the receiving terminal.

Whether to perform the measurement operation for transmission beams, whether to perform the measurement operation for reception beams, and/or whether to perform BSI reporting may be preconfigured before the transmission of the BSI request. In this case, variant exemplary embodiments, extended exemplary embodiments, and/or combined exemplary embodiments from the above-described exemplary embodiments may be used. Whether to perform the measurement operation for transmission beams, whether to perform the measurement operation for reception beams, and/or whether to perform BSI reporting may be preconfigured through SI signaling, RRC signaling, and/or MAC signaling. The above-described exemplary embodiments may be performed based on configuration through SI signaling, RRC signaling, and/or MAC signaling.

If the measurement operation for the transmission beam(s) of the transmitting terminal is performed, the receiving terminal may report measurement information (e.g., BSI) for the transmission beam(s) to the transmitting terminal. If the measurement operation for the reception beam(s) of the receiving terminal is performed, the receiving terminal may not report the measurement information for the reception beam(s) to the transmitting terminal. Since the measurement information for reception beams is not used by the transmitting terminal, the measurement information for reception beams may not be transmitted to the transmitting terminal. The receiving terminal may change or maintain reception beam(s) based on the measurement information for the reception beam. In other words, the receiving terminal may perform beam management operations based on the measurement information for the reception beams.

The information indicating the measurement operation for the transmission beams of the transmitting terminal may be separated from the information indicating whether to report the measurement results (e.g., results of the measurement operation). The information indicating the measurement operation for the reception beams of the receiving terminal may also be separated from the information indicating whether to report the measurement results (e.g., results of the measurement operation). An indicator having a size of 2 bits may be used for the above indication operations. For example, one bit of the indicator may indicate whether to perform the measurement operation for the transmission beams or reception beams, and the other bit of the indicator may indicate whether to perform BSI reporting. The indicator may be defined as shown in Table 4 below.

TABLE 4

| Indication bits | Indicated operation |
|---|---|
| 00 | Measurement operation for transmission |
| | beams, BSI reporting operation |
| 01 | Measurement operation for transmission |
| | beams, no BSI reporting operation |
| 10 | Measurement operation for reception |
| | beams, BSI reporting operation |
| 11 | Measurement operation for reception |
| | beams, no BSI reporting operation |

The indicator in Table 4 may be transmitted through signaling (e.g., RRC signaling, MAC signaling, and/or PHY signaling). A variant indicator from the indicator in Table 4, an extended indicator from the indicator in Table 4, and/or a combined indicator from the indicator in Table 4 may be used.

The BSI request may include information on the number of S-SSB periods. In other words, the information included in the BSI request may limit the number of S-SSBs transmitted for beam measurement (e.g., BSI measurement). For example, if the information included in the BSI request indicates two S-SSB periods, and four S-SSB transmissions are indicated in each of the two S-SSB periods, the transmitting terminal may transmit eight S-SSBs for BSI measurement, and the receiving terminal may perform measurement operations for the eight S-SSBs. The BSI request may include an indicator indicating the number of S-SSB periods, the size of which may be 2 bits. The indicator may indicate 2, 4, 6, or 8 as the number of S-SSB periods. The indicator may indicate various numbers of S-SSB periods and may be configured in various forms.

The receiving terminal may measure beam information based on the S-SSBs transmitted by the transmitting terminal and may report BSI, which includes measurement results of the beam information, to the transmitting terminal. When the BSI report is received from the receiving terminal, the transmitting terminal may stop S-SSB transmission. If it is determined that additional measurement of beam information is not needed, the S-SSB transmission may be stopped. To support the above operation, the BSI transmitted by the receiving terminal may include not only the measurement information of the beams but also information indicating whether to stop the S-SSB transmission. If the information included in the BSI indicates stopping the S-SSB transmission, the transmitting terminal may stop the S-SSB transmission after receiving the BSI. If the information included in the BSI indicates continuing the S-SSB transmission, the transmitting terminal may continue the S-SSB transmission after receiving the BSI.

Alternatively, in the procedure where the transmitting terminal configures the transmission of S-SSBs for BSI measurement, no additional S-SSB transmissions may be configured to be performed after reception of the BSI report. The configuration that no additional S-SSB transmissions are performed after reception of the BSI report may be achieved through the BSI report and/or higher-layer signaling. This operation may be applied identically or similarly even when the number of S-SSB periods is not set (e.g., when periodic S-SSB transmissions are performed).

The BSI request may include information on the number of S-SSBs and/or an S-SSB group to be measured for the BSI report. In other words, the BSI request may include information of a range of S-SSBs measured for the BSI report. The BSI request may include information on a pattern regarding the beams transmitting the S-SSBs.

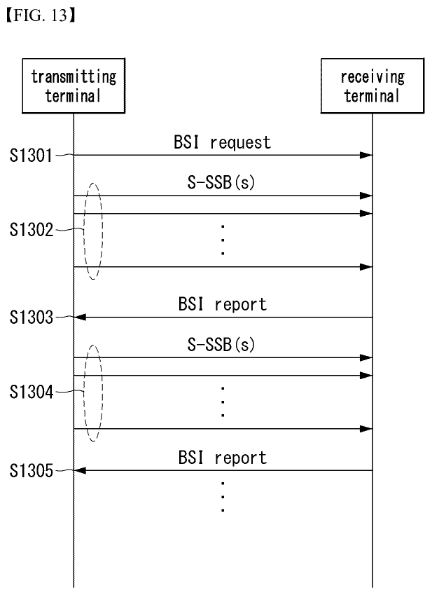

FIG. 13 is a sequence chart illustrating a third exemplary embodiment of a beam management method.

As shown in FIG. 13, the transmitting terminal may transmit a BSI request to the receiving terminal (S1301). The receiving terminal may receive the BSI request from the transmitting terminal and may identify information element(s) included in the BSI request. When the BSI request is received, the receiving terminal may expect transmission of S-SSBs associated with the BSI request. The transmitting terminal may transmit the S-SSBs to the receiving terminal after transmitting the BSI request (S1302). The S-SSBs may be associated with the BSI request. The transmission of the S-SSBs may be triggered by the BSI request. The receiving terminal may perform measurement operations for a preset number of S-SSBs or S-SSBs within a preset number of S-SSB periods and may generate BSI that includes results of the measurement operations. In other words, the receiving terminal may perform the measurement operations on S-SSBs belonging to a preconfigured range.

The receiving terminal may report the BSI to the transmitting terminal (S1303). The transmitting terminal may receive the BSI from the receiving terminal. The transmitting terminal may perform beam management operations based on the BSI. After receiving the BSI from the receiving terminal, the transmitting terminal may transmit S-SSBs to the receiving terminal (S1304). The receiving terminal may perform measurement operations for a preset number of S-SSBs or S-SSBs within a preset number of S-SSB periods and may generate BSI that includes results of the measurement operations. The receiving terminal may report the BSI to the transmitting terminal (S1305). The transmitting terminal may perform beam management operations based on the BSI.

When it is configured that beam information (e.g., BSI) is measured for each unit of S-SSB period(s) and BSI reporting is performed for each unit of S-SSB period(s), the receiving terminal may report the BSI measured for each unit of S-SSB period(s). For example, when it is configured that beam information (e.g., BSI) is measured for each unit of four S-SSB periods and BSI reporting is performed for each unit of four S-SSB periods, the receiving terminal may report the BSI measured for every four S-SSB periods. The range of S-SSBs measured for the BSI report may be configured in units of S-SSB periods, in units of S-SSBs, in units of slots, in configurable units, and/or as a combination of those units.

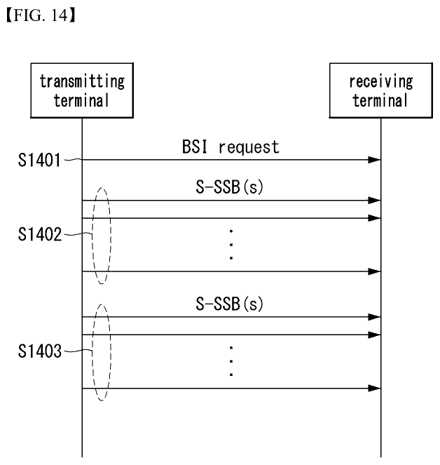

FIG. 14 is a sequence chart illustrating a fourth exemplary embodiment of a beam management method.

As shown in FIG. 14, the transmitting terminal may transmit a BSI request to the receiving terminal (S1401). The receiving terminal may receive the BSI request from the transmitting terminal and may identify information element(s) included in the BSI request. When the BSI request is received, the receiving terminal may expect transmission of S-SSBs associated with the BSI request. The transmitting terminal may transmit the S-SSBs to the receiving terminal (S1402). The receiving terminal may perform measurement operations for a preset number of S-SSBs or S-SSBs within a preset number of S-SSB periods and may generate BSI that includes results of the measurement operations. In other words, the receiving terminal may perform the measurement operations on S-SSBs belonging to a preconfigured range.

When BSI reporting is configured not to be performed, the receiving terminal may not report BSI to the transmitting terminal. In other words, even when BSI reporting is configured not to be performed, the execution of the BSI measurement operations for the preset number of S-SSBs or S-SSBs within the preset number of S-SSB periods may be indicated.

Additionally, the transmitting terminal may transmit the S-SSBs to the receiving terminal (S1403). The BSI measurement operations for the preset number of S-SSB(s) or S-SSB(s) within the preset number of S-SSB periods may be performed by the receiving terminal. The preset number of S-SSBs or S-SSBs within the preset number of S-SSB periods for the BSI measurement may be referred to as an S-SSB group. In the exemplary embodiments of FIG. 13 and/or FIG. 14, indication regarding whether to perform the BSI reporting may be provided for each S-SSB group.

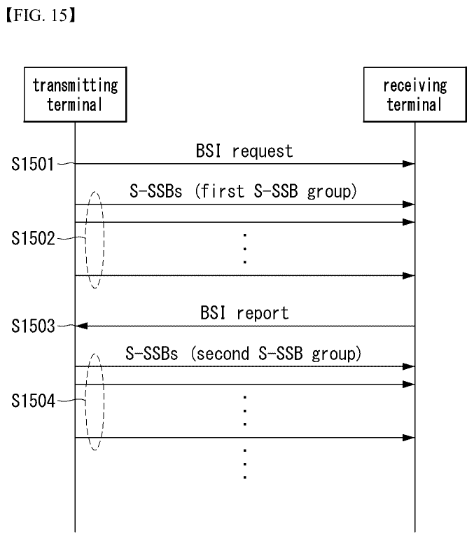

FIG. 15 is a sequence chart illustrating a fifth exemplary embodiment of a beam management method.

As shown in FIG. 15, terminal(s) may be indicated or configured to perform BSI reporting for a first S-SSB group, and may be indicated or configured not to perform BSI reporting for a second S-SSB group. When the indication regarding whether to perform BSI reporting implicitly indicates a transmission beam measurement operation or a reception beam measurement operation, the transmission beam measurement operation for the first S-SSB group may be implicitly indicated, and the reception beam measurement operation for the second S-SSB group may be implicitly indicated. Alternatively, the transmission beam measurement operation or the reception beam measurement operation may be explicitly indicated for each S-SSB group, and the transmitting terminal and/or the receiving terminal may operate regardless of whether BSI reporting is performed.

The transmitting terminal may transmit a BSI request to the receiving terminal (S1501). The receiving terminal may receive the BSI request from the transmitting terminal and may identify information element(s) included in the BSI request. When the BSI request is received, the receiving terminal may expect transmission of S-SSBs associated with the BSI request from the transmitting terminal. The transmitting terminal may perform transmission of the first S-SSB group (S1502). The receiving terminal may perform a measurement operation on the first S-SSB group and may generate BSI that includes results of the measurement operation. When a measurement operation for transmission beams of the transmitting terminal is indicated or performing BSI reporting is indicated, the receiving terminal may report the BSI to the transmitting terminal (S1503).

The transmitting terminal may receive the BSI from the receiving terminal. The transmitting terminal may perform beam management operations based on the BSI. For example, the transmitting terminal may maintain or change transmission beam(s) based on the BSI. After the BSI is received from the receiving terminal, the transmitting terminal may perform transmission of the second S-SSB group (S1504). The receiving terminal may perform a measurement operation on the second S-SSB group. When a measurement operation for reception beams of the receiving terminal is indicated or not performing BSI reporting is indicated, the receiving terminal may not report the BSI to the transmitting terminal. When the measurement operation for the reception beams of the receiving terminal is indicated, the receiving terminal may perform the measurement operation for the reception beams based on the second S-SSB group. The measurement operation for the reception beams may be performed based on a beam sweeping scheme. The receiving terminal may maintain or change reception beam(s) based on measurement results for the second S-SSB group.

Different beam patterns may be applied to the S-SSB groups or S-SSB periods, respectively. The transmitting terminal may perform the transmission of the S-SSB group(s) using different beam patterns. The receiving terminal may perform the reception operation for the S-SSB group(s) using different beam patterns. The transmitting terminal may transmit the S-SSBs in S-SSB periods using different beam patterns. The receiving terminal may perform the reception operation for the S-SSBs in the S-SSB periods using different beam patterns.

Configuration information for the S-SSB group(s), information indicating whether to perform a measurement operation for transmission beams for each S-SSB group, information indicating whether to perform a measurement operation for reception beams for each S-SSB group, information indicating whether to perform BSI reporting for each S-SSB group, information on a transmission beam pattern, and/or information on a reception beam pattern may be included in the BSI request. The configuration information for the S-SSB group(s), information indicating whether to perform a measurement operation for transmission beams for each S-SSB group, information indicating whether to perform a measurement operation for reception beams for each S-SSB group, information indicating whether to perform BSI reporting for each S-SSB group, information on a transmission beam pattern, and/or information on a reception beam pattern may be transmitted through at least one of RRC signaling, MAC signaling, or PHY signaling.

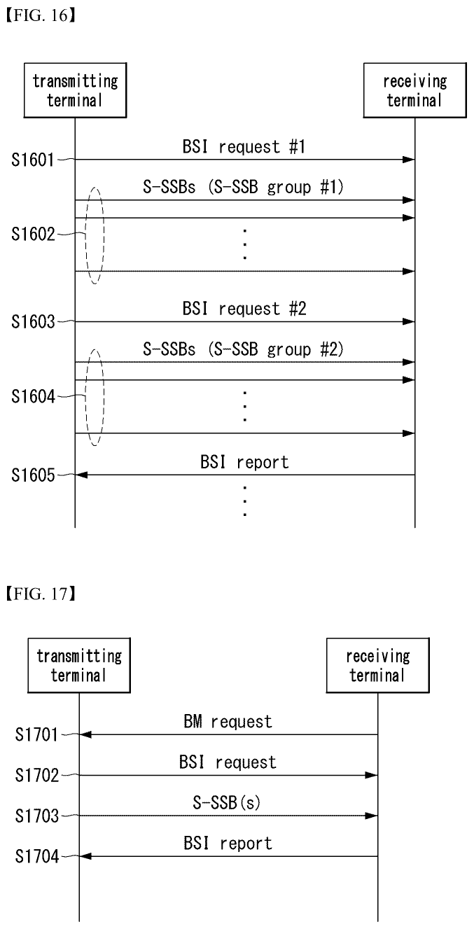

FIG. 16 is a sequence chart illustrating a sixth exemplary embodiment of a beam management method.

As shown in FIG. 16, after transmission of a single BSI request, the entire S-SSB period for beam measurement may be configured to be identical to a single S-SSB group. In this case, the transmitting terminal may transmit a BSI request for each S-SSB group. For example, the transmitting terminal may transmit a BSI request #1 for an S-SSB group #1 and transmit a BSI request #2 for an S-SSB group #2. When indicated to perform BSI reporting, the receiving terminal may report BSI measured for a single S-SSB group to the transmitting terminal. BSI reporting for the BSI request #1 may not be indicated, and BSI reporting for the BSI request #2 may be indicated. The receiving terminal may report BSI measured for the S-SSB group #2 to the transmitting terminal.

The transmitting terminal may transmit the BSI request #1 to the receiving terminal (S1601). The receiving terminal may receive the BSI request #1 from the transmitting terminal and may identify information element(s) included in BSI request #1. When the BSI request #1 is received, the receiving terminal may expect transmission of the S-SSB group #1 associated with the BSI request #1 to be performed by the transmitting terminal. The transmitting terminal may perform the transmission for the S-SSB group #1 (S1602). The receiving terminal may perform measurement operations on the S-SSB group #1. When not indicated to perform BSI reporting for the S-SSB group #1, the receiving terminal may not report results (e.g., BSI) of the measurement operations on the S-SSB group #1 to the transmitting terminal.

The transmitting terminal may transmit the BSI request #2 to the receiving terminal (S1603). The receiving terminal may receive the BSI request #2 from the transmitting terminal and may identify information element(s) included in BSI request #2. When the BSI request #2 is received, the receiving terminal may expect transmission of the S-SSB group #2 associated with the BSI request #2 to be performed by the transmitting terminal. The transmitting terminal may perform the transmission for the S-SSB group #2 (S1604). The receiving terminal may perform measurement operations on the S-SSB group #2. When indicated to perform BSI reporting for the S-SSB group #2, the receiving terminal may report results (e.g., BSI) of the measurement operations on the S-SSB group #2 to the transmitting terminal (S1605). The transmitting terminal may receive the BSI measured for the S-SSB group #2 from the receiving terminal. The transmitting terminal may maintain or change transmission beam(s) based on the BSI.

All or part of the information element(s) that may be included in the BSI request in the present disclosure may be configured through higher-layer signaling (e.g., SI signaling, RRC signaling, and/or MAC signaling). In this case, a variant exemplary embodiment, an extended exemplary embodiment, and/or a combined exemplary embodiment from the above exemplary embodiments may be performed.

The transmitting terminal that transmits the S-SSBs for beam measurement may be a synchronization terminal (e.g., synchronization reference terminal). The synchronization terminal (e.g., transmitting terminal) may transmit S-SSBs for synchronization with the receiving terminal. When the S-SSB-based beam management operation is performed, the receiving terminal may consider the transmitting terminal as a synchronization terminal, may acquire synchronization information based on an S-SSB received from the transmitting terminal, and may correct synchronization. In other words, the receiving terminal may synchronize with the transmitting terminal based on the S-SSB received from the transmitting terminal.

In the above exemplary embodiments, a triggering signal for the beam measurement operation and/or BSI reporting may be the BSI request from the transmitting terminal. Condition(s) under which the transmitting terminal transmits the BSI request may be configured to the terminal(s) (e.g., transmitting terminal and/or receiving terminal) through higher-layer signaling (e.g., SI signaling, RRC signaling, and/or MAC signaling). When the condition(s) configured by higher-layer signaling are satisfied, the transmitting terminal may transmit the BSI request. When the condition(s) configured by higher-layer signaling are satisfied, the receiving terminal may expect the transmitting terminal to transmit the BSI request.

For example, when a quality of SL communication (e.g., beam-based SL communication) is equal to or less than a threshold and/or a measurement result for a reference signal (e.g., CSI-RS) transmitted by the transmitting terminal is equal to or less than a threshold, the transmitting terminal may transmit a BSI request to trigger a beam management operation. After transmitting the BSI request, the transmitting terminal may transmit S-SSB(s). The beam management operation may be performed based on measurement results for the S-SSB(s). A quality of a beam (e.g., measurement result) may be represented by RSRP, RSRQ, RSSI, etc. Alternatively, a quality of a beam may be a result of a specific operation involving RSRP, RSRQ, and/or RSSI.

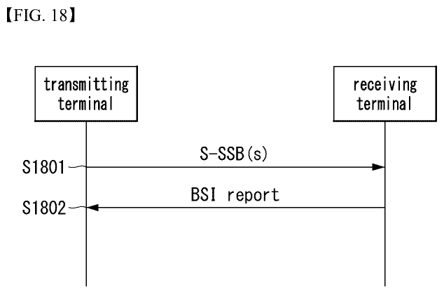

FIG. 17 is a sequence chart illustrating a seventh exemplary embodiment of a beam management method.

As shown in FIG. 17, the receiving terminal may transmit a beam management (BM) request to the transmitting terminal (S1701). The BM request may include information indicating whether a beam management operation is required. If it is determined that a beam management operation is required, the receiving terminal may transmit the BM request to the transmitting terminal. The BM request may include information indicating that a beam management operation is required. The beam measurement operation and/or BSI reporting operation may be triggered by the receiving terminal (e.g., the BM request from the receiving terminal). The BM request may be transmitted through a PSCCH and/or PSSCH. In this case, the BM request may be included in SCI and/or MAC CE. Alternatively, the BM request may be transmitted through a PSFCH. The size of the BM request may be 1 bit. When the BM request is transmitted through a PSFCH, the BM request may be configured in a form of a preconfigured sequence requesting to perform a beam management operation. When the BM request is indicated using 1 bit of information, the BM request set to a first value (e.g., 0) may indicate that a beam management operation is not required. The BM request set to a second value (e.g., 1) may indicate that a beam management operation is required. The transmitting terminal may receive the BM request from the receiving terminal. When the BM request is received from the receiving terminal, the transmitting terminal may determine that a beam management operation is required. Alternatively, the transmitting terminal may determine that a beam management operation is required based on the information included in the BM request. Accordingly, the transmitting terminal may transmit a BSI request to the receiving terminal (S1702).

The receiving terminal may receive the BSI request from the transmitting terminal and may identify information element(s) included in the BSI request. When the BSI request is received, the receiving terminal may expect S-SSB(s) associated with the BSI request to be received from the transmitting terminal. After the BSI request is transmitted, the transmitting terminal may transmit the S-SSB(s) to the receiving terminal (S1703). The receiving terminal may perform a measurement operation on the S-SSB(s) of the transmitting terminal and may report BSI, which includes measurement results, to the transmitting terminal (S1704). The transmitting terminal may receive the BSI from the receiving terminal and may perform beam management operations based on the BSI. For example, the transmitting terminal may maintain or change transmission beam(s) based on the BSI. The transmission and reception operation of the BM request (e.g., S1701) may be applied to at least one of the exemplary embodiments described in FIGS. 11 to 16. The operations following S1701 in the exemplary embodiment of FIG. 17 may be identical or similar to the operations in at least one of the exemplary embodiments described in FIGS. 11 to 16.

FIG. 18 is a sequence chart illustrating an eighth exemplary embodiment of a beam management method.

As shown in FIG. 18, the S-SSB-based beam management operation may be performed without a BSI request from the transmitting terminal. Configuration values (e.g., all configuration values) for transmission of S-SSBs for beam management operations may be preconfigured for the terminal(s) through signaling (e.g., SI signaling, RRC signaling, and/or MAC signaling). The transmitting terminal may transmit the S-SSB(s) to the receiving terminal(s) without transmitting a BSI request (S1801). The receiving terminal(s) performing SL communication with the transmitting terminal may receive the S-SSB(s) from the transmitting terminal and may measure beam qualities based on the S-SSB(s). The receiving terminal(s) may report beam quality information (e.g., BSI) to the transmitting terminal (S1802). The transmitting terminal may receive the BSI from the receiving terminal(s). The transmitting terminal may maintain or change transmission beam(s) based on the BSI.

Variant exemplary embodiments, extended exemplary embodiments, and/or combined exemplary embodiments from the exemplary embodiment in FIG. 18 may be performed. The combined exemplary embodiment may be a combination of the exemplary embodiment in FIG. 18 and other exemplary embodiments of the present disclosure. The transmitting terminal may be a synchronization terminal (e.g., synchronization reference terminal) for the receiving terminal. Alternatively, the transmitting terminal may serve as a synchronization terminal replacing the existing synchronization reference terminal of the receiving terminal. In this case, the receiving terminal may receive S-SSB(s) (e.g., S-SSB for beam management operations) and may perform a synchronization correction operation, beam quality measurement operation, BSI reporting operation, and the like based on the S-SSB(s).

In the present disclosure, the S-SSB for beam management operations may be distinguished from the S-SSB for synchronization. In this case, the S-SSB for beam management operations and/or the S-SSB for synchronization may be configured to the terminal through signaling. Transmission resources (e.g., time resources, frequency resources, transmission period) of the S-SSB(s) for beam management operations may be configured differently from those of the S-SSB(s) for synchronization. Alternatively, the S-SSB(s) for beam management operations may be the same as the S-SSB for synchronization.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
transmitting a beam state information (BSI) request to a second UE;
transmitting first sidelink-synchronization signal blocks (S-SSBs) according to the BSI request to the second UE; and
receiving first BSI measured based on the first S-SSBs from the second UE.

2. The method according to claim 1, wherein the BSI request includes configuration information of the first S-SSBs, and the configuration information includes at least one of time resource information, frequency resource information, or transmission periodicity information of the first S-SSBs.

3. The method according to claim 1, wherein the first S-SSBs are configured for beam management operations, and the first S-SSBs are distinguished from S-SSBs configured for synchronization.

4. The method according to claim 1, wherein the BSI request includes information indicating whether to perform BSI reporting, the first BSI is received from the second UE when the information indicates that BSI reporting is to be performed, and the first BSI is not received from the second UE when the information indicates that BSI reporting is not to be performed.

5. The method according to claim 1, wherein the BSI request is included in sidelink control information (SCI), medium access control (MAC) control element (CE), or radio resource control (RRC) message transmitted to the second UE.

6. The method according to claim 1, wherein the first BSI includes measurement information for beams of the first UE and information indicating whether to stop S-SSB transmission, the first UE stops S-SSB transmission after receiving the first BSI when the information indicates that S-SSB transmission is to be stopped, and the first UE performs S-SSB transmission after receiving the first BSI when the information indicates that S-SSB transmission is not to be stopped.

7. The method according to claim 1, further comprising:
transmitting second S-SSBs to the second UE; and
receiving second BSI measured based on the second S-SSBs from the second UE,
wherein the first S-SSBs constitute a first S-SSB group, the second S-SSBs constitute a second S-SSB group, and BSI measurement operations in the second UE are performed on an S-SSB group basis.

8. The method according to claim 1, further comprising: receiving a beam management (BM) request from the second UE,
wherein the BM request includes information indicating whether a beam management operation is required, the first UE transmits the BSI request when the information indicates that a beam management operation is required, and the first UE does not transmit the BSI request when the information indicates that a beam management operation is not required.

9. A method of a second user equipment (UE), comprising:
receiving a beam state information (BSI) request from a first UE;
receiving first sidelink-synchronization signal blocks (S-SSBs) according to the BSI request from the first UE;
generating first BSI by performing beam measurement operations based on the first S-SSBs; and
transmitting the first BSI to the first UE.

10. The method according to claim 9, wherein the BSI request includes configuration information of the first S-SSBs, and the configuration information includes at least one of time resource information, frequency resource information, or transmission periodicity information of the first S-SSBs.

11. The method according to claim 9, wherein the first S-SSBs are configured for beam management operations, and the first S-SSBs are distinguished from S-SSBs configured for synchronization.

12. The method according to claim 9, wherein the BSI request includes information indicating whether to perform BSI reporting, the second UE transmits the first BSI to the first UE when the information indicates that BSI reporting is to be performed, and the second UE does not transmit the first BSI to the first UE when the information indicates that BSI reporting is not to be performed.

13. The method according to claim 9, wherein the BSI request is included in sidelink control information (SCI), medium access control (MAC) control element (CE), or radio resource control (RRC) message received from the first UE.

14. The method according to claim 9, wherein the first BSI includes measurement information for beams of the first UE and information indicating whether to stop S-SSB transmission, the second UE stops S-SSB reception after transmitting the first BSI when the information indicates that S-SSB transmission is to be stopped, and the second UE performs S-SSB reception after transmitting the first BSI when the information indicates that S-SSB transmission is not to be stopped.

15. The method according to claim 9, further comprising:
receiving second S-SSBs from the first UE;
generating second BSI by performing beam measurement operations based on the second S-SSBs; and
transmitting the second BSI to the first UE,
wherein the first S-SSBs constitute a first S-SSB group, the second S-SSBs constitute a second S-SSB group, and the second UE performs the beam measurement operations on an S-SSB group basis.

16. The method according to claim 9, further comprising: transmitting a beam management (BM) request to the first UE,
wherein the BM request includes information indicating whether a beam management operation is required, the second UE performs a reception operation for the BSI request when the information indicates that a beam management operation is required, and the second UE does not perform a reception operation for the BSI request when the information indicates that a beam management operation is not required.

17. A first user equipment (UE) comprising at least one processor, wherein the at least one processor causes the first UE to perform:
transmitting a beam state information (BSI) request to a second UE;
transmitting first sidelink-synchronization signal blocks (S-SSBs) according to the BSI request to the second UE; and
receiving first BSI measured based on the first S-SSBs from the second UE.

18. The first UE according to claim 17, wherein the BSI request includes configuration information of the first S-SSBs, the configuration information includes at least one of time resource information, frequency resource information, or transmission periodicity information of the first S-SSBs, the first S-SSBs are configured for beam management operations, and the first S-SSBs are distinguished from S-SSBs configured for synchronization.

19. The first UE according to claim 17, wherein the at least one processor causes the first UE to perform:
transmitting second S-SSBs to the second UE; and
receiving second BSI measured based on the second S-SSBs from the second UE,
wherein the first S-SSBs constitute a first S-SSB group, the second S-SSBs constitute a second S-SSB group, and BSI measurement operations in the second UE are performed on an S-SSB group basis.

20. The first UE according to claim 17, wherein the at least one processor causes the first UE to perform: receiving a beam management (BM) request from the second UE,
wherein the BM request includes information indicating whether a beam management operation is required, the first UE transmits the BSI request when the information indicates that a beam management operation is required, and the first UE does not transmit the BSI request when the information indicates that a beam management operation is not required.
